(19) United States
(12) Patent Application Publication
(10) Pub. No.: US 2017/0032301 A1
(43) Pub. Date: Feb. 2, 2017

(54) Loss of Primary Containment Management System

(71) Applicant: Michael Marshall, LLC, Findlay, OH (US)

(72) Inventor: Michael Marshall, Findlay, OH (US)

(21) Appl. No.: 15/194,559

(22) Filed: Jun. 27, 2016

Related U.S. Application Data
(63) Continuation-in-part of application No. 62/184,336, filed on Jun. 25, 2015.

(51) Int. Cl. G06Q 10/06

(52) U.S. Cl. CPC G06Q 10/06313; G06Q 10/06393; G06Q 10/0635

(57) ABSTRACT

An enterprise asset management platform is disclosed. Said system comprising at least one memory including computer program code. at least one processor. The at least one memory and the computer program code are configured to, with the at least one processor, cause the management system to at least perform the steps of: receiving direct input from a one or more users concerning conditions of a loss of primary containment event “LOPCE” at an industrial location, consulting a one or more outside inputs concerning the LOPCE, diagnosing a condition of the industrial location based on the direct input and the one or more outside inputs, optimizing the industrial location based on the condition of the industrial location, and providing a one or more tools for managing the industrial location. The LOPCE comprises an active event, a possible event and/or a past event at the industrial location or similar locations.

### CROSS-REFERENCE TO RELATED APPLICATIONS

This application claims benefit to U.S. Patent Application No. 62/184,336.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

This disclosure relates generally to a loss of primary containment management system.

None of the above inventions and patents, taken either singularly or in combination, is seen to describe the instant disclosure as claimed. Accordingly, an improved loss of primary containment management system would be advantageous.

### BRIEF SUMMARY OF THE INVENTION

An enterprise asset management platform is disclosed. Said system comprising at least one memory including computer program code. at least one processor. The at least one memory and the computer program code are configured to, with the at least one processor, cause the management system to at least perform the steps of: receiving direct input from a one or more users concerning conditions of a loss of primary containment event “LOPCE” at an industrial location, consulting a one or more outside inputs concerning the LOPCE, diagnosing a condition of the industrial location based on the direct input and the one or more outside inputs, optimizing the industrial location based on the condition of the industrial location, and providing a one or more tools for managing the industrial location. The LOPCE comprises an active event, a possible event and/or a past event at the industrial location or similar locations.

### BRIEF DESCRIPTION OF THE SEVERAL VIEWS OF THE DRAWING

FIG. 1 illustrates a first network configuration 101 of a LOCMS system 100. In one embodiment, said LOCMS system 100 can comprise a one or more computers at a one or more locations.

FIGS. 2A, 2B and 2C illustrate a perspective overview of a mobile phone 201a, a personal computer 201b and a tablet 201c.

FIGS. 3A, 3B and 3C illustrate an address space 302 within said one or more computers, an address space 302a and an address space 302d.

FIGS. 4A and 4B illustrate two embodiments for collecting and storing data with said LOCMS system 100; a first embodiment with a flow diagram between said first computer 102a and said server 108, and a second embodiment comprising of just said first computer 102a.

FIGS. 5A and 5B illustrate two examples of a flow diagram between said memory 306a and said memory 306d.

FIG. 6 illustrates a system procedures overview 600.

FIGS. 7-10 illustrate the who, what, when, where and how of doing just that with a focused, metrics-driven LOPC Management System (“LOCMS”).

FIG. 7 illustrates a LOCM Repeating Process 700.

FIG. 8 illustrates a summary of KPI development and improvement (a integrated management systems illustration 800).

FIG. 10 illustrates a system inputs diagram 1000 between a workforce said device application 502.

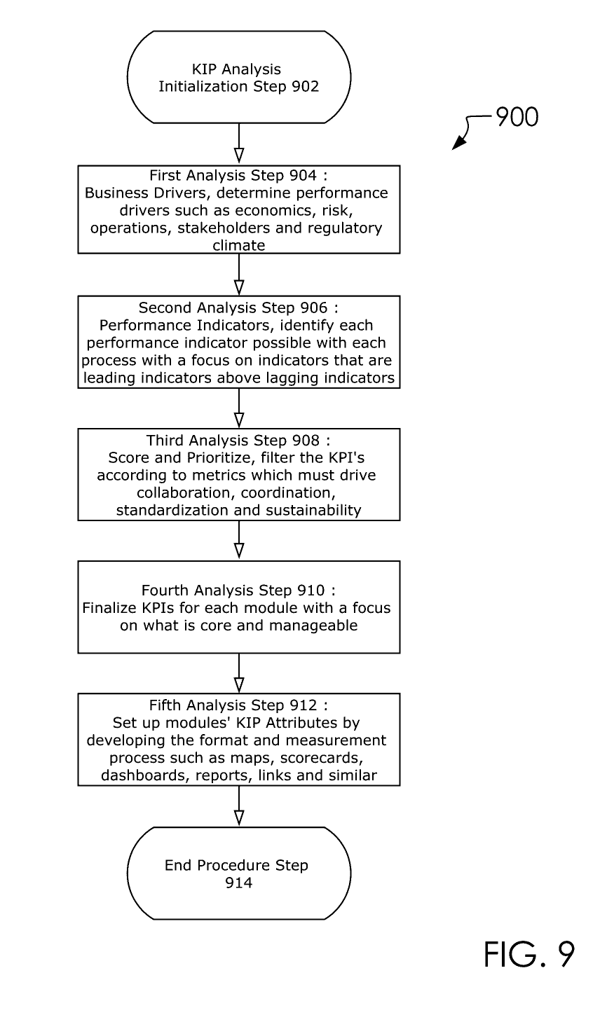

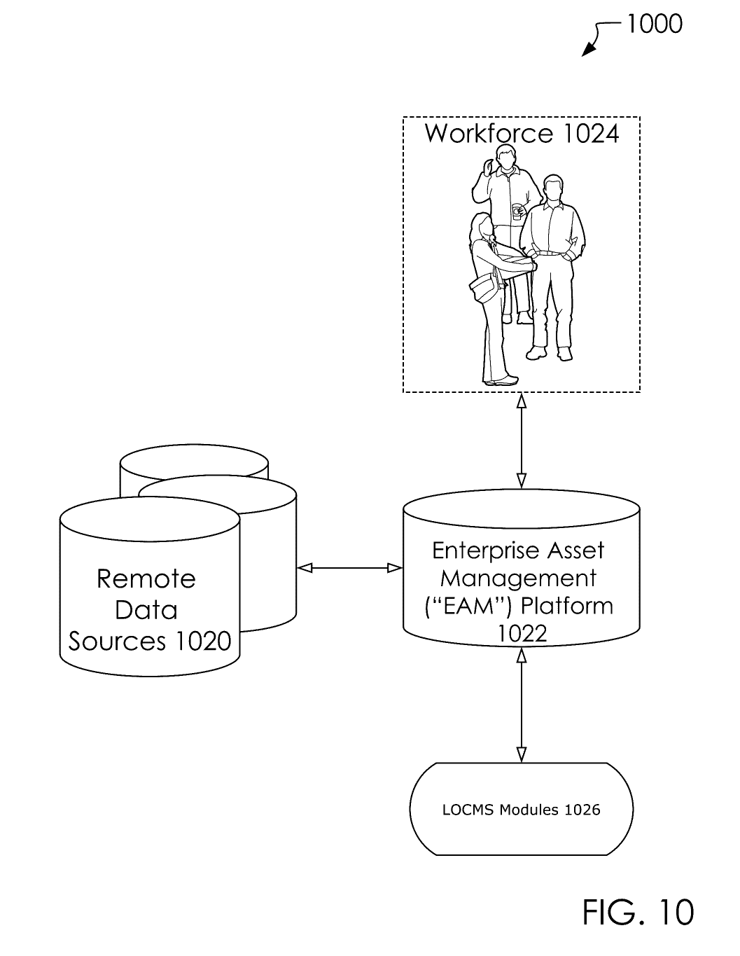

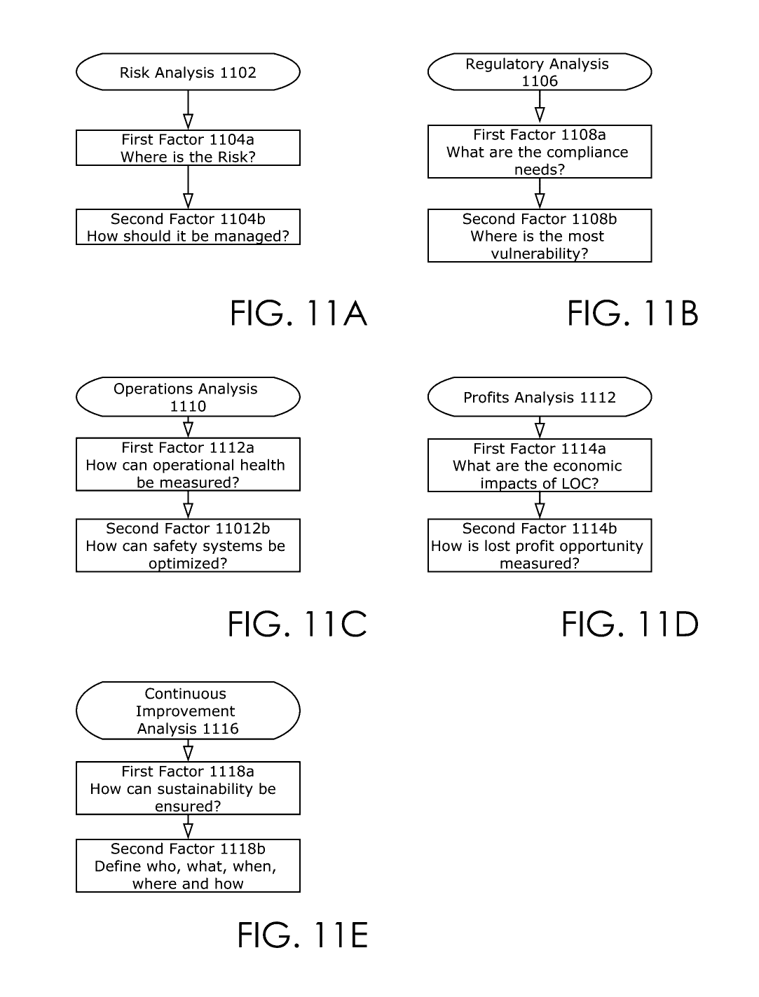

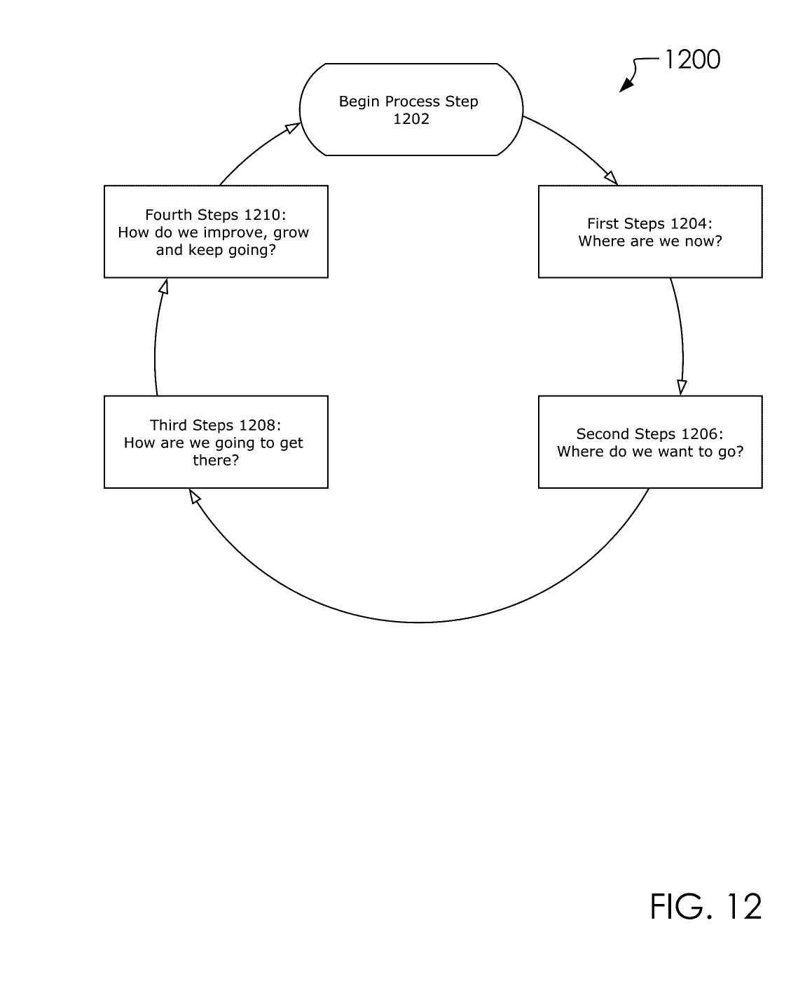

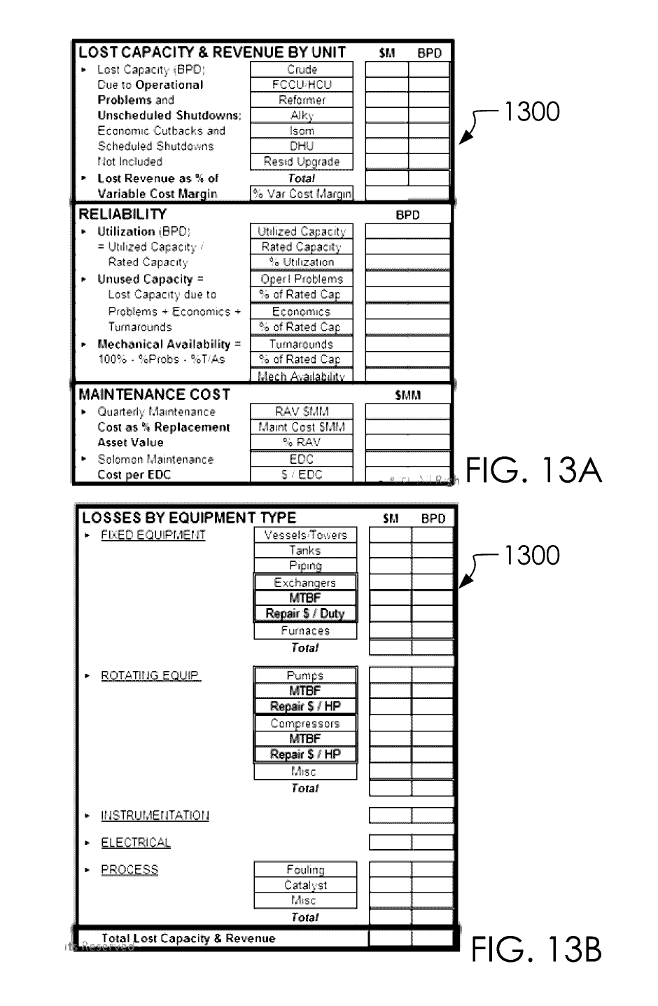

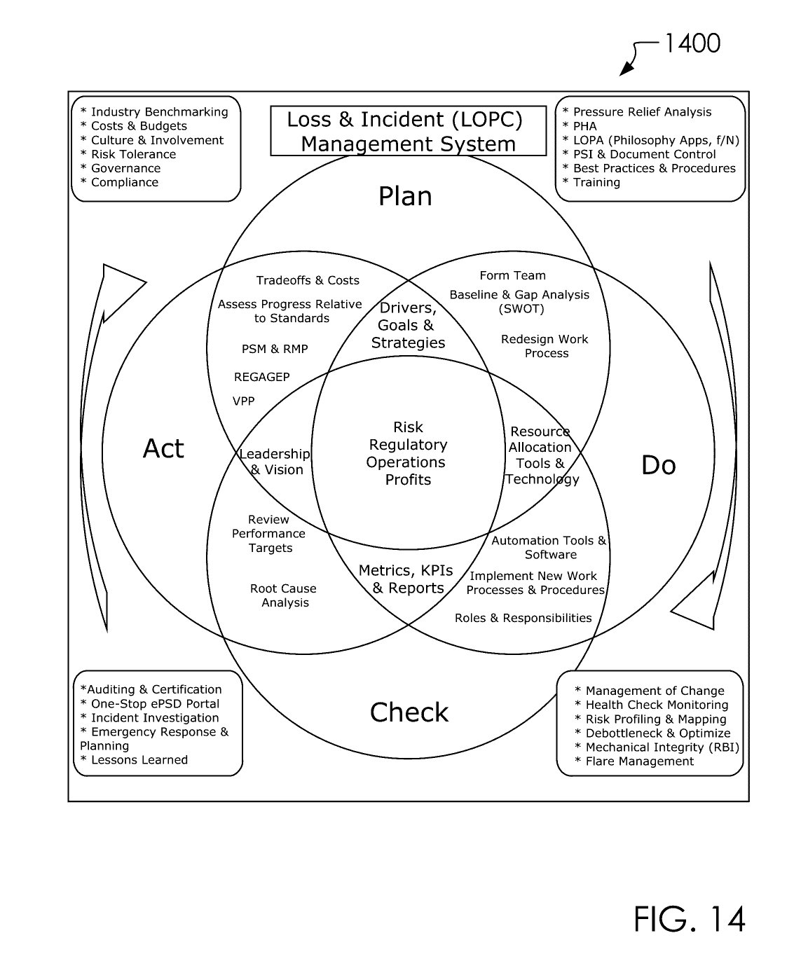

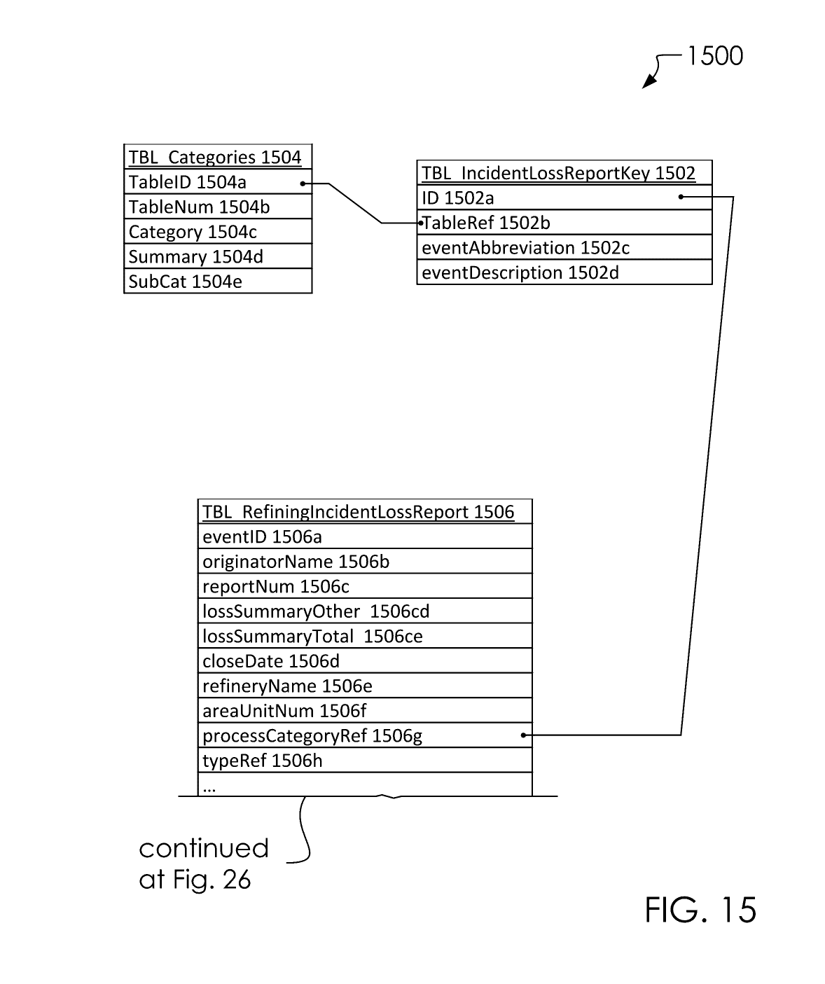

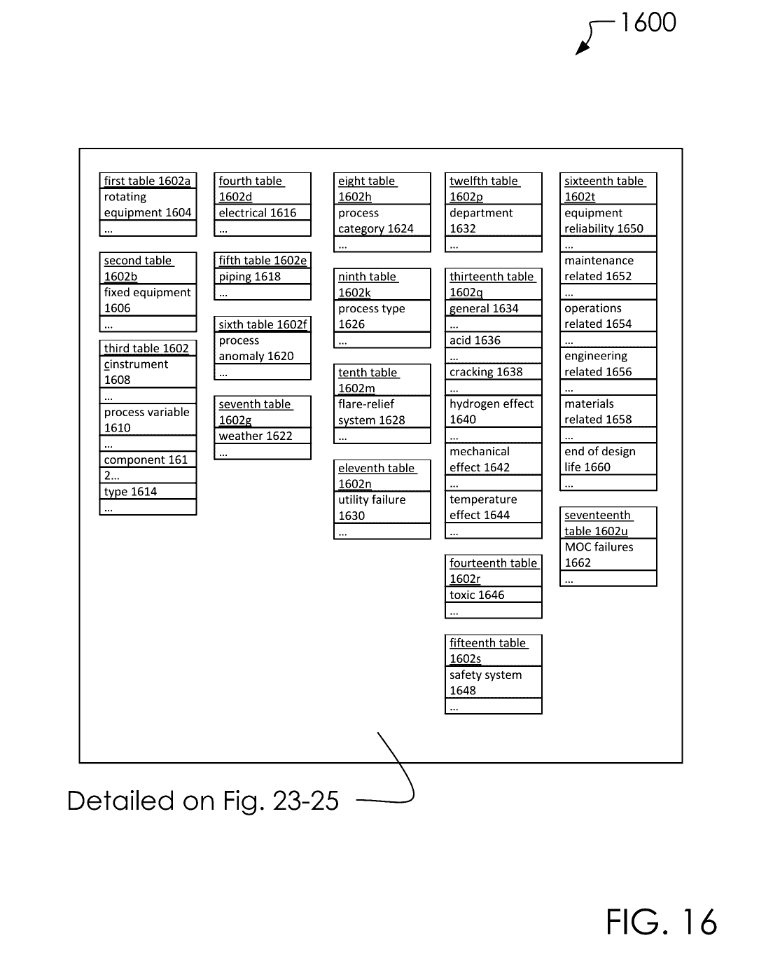

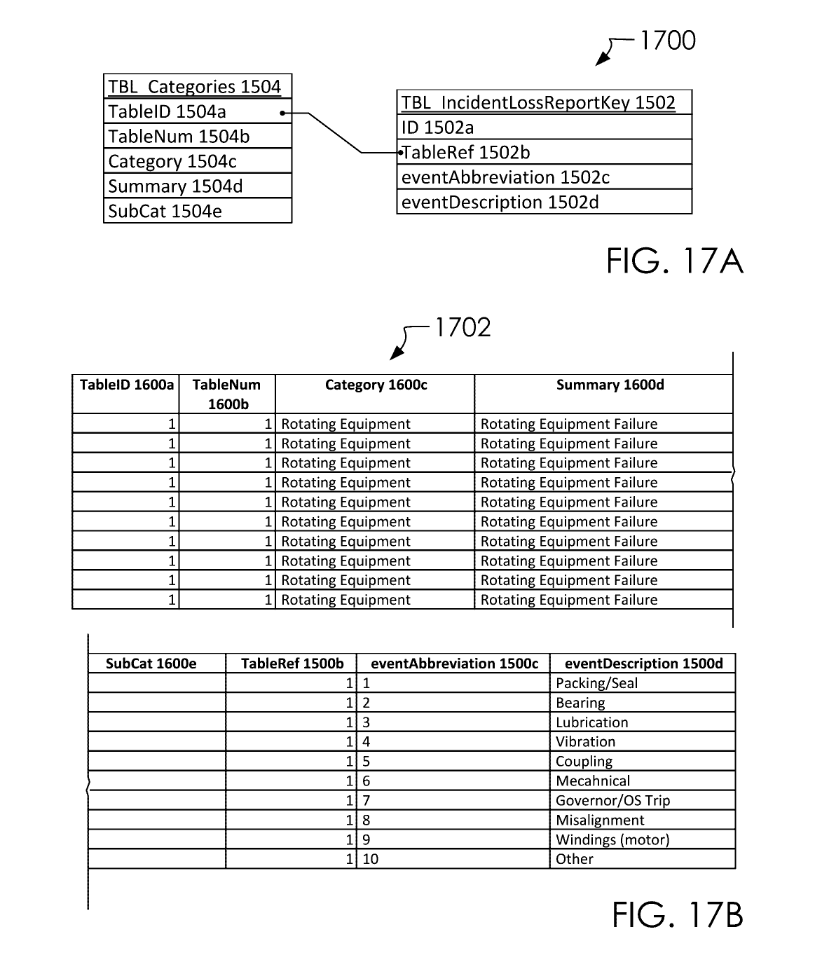

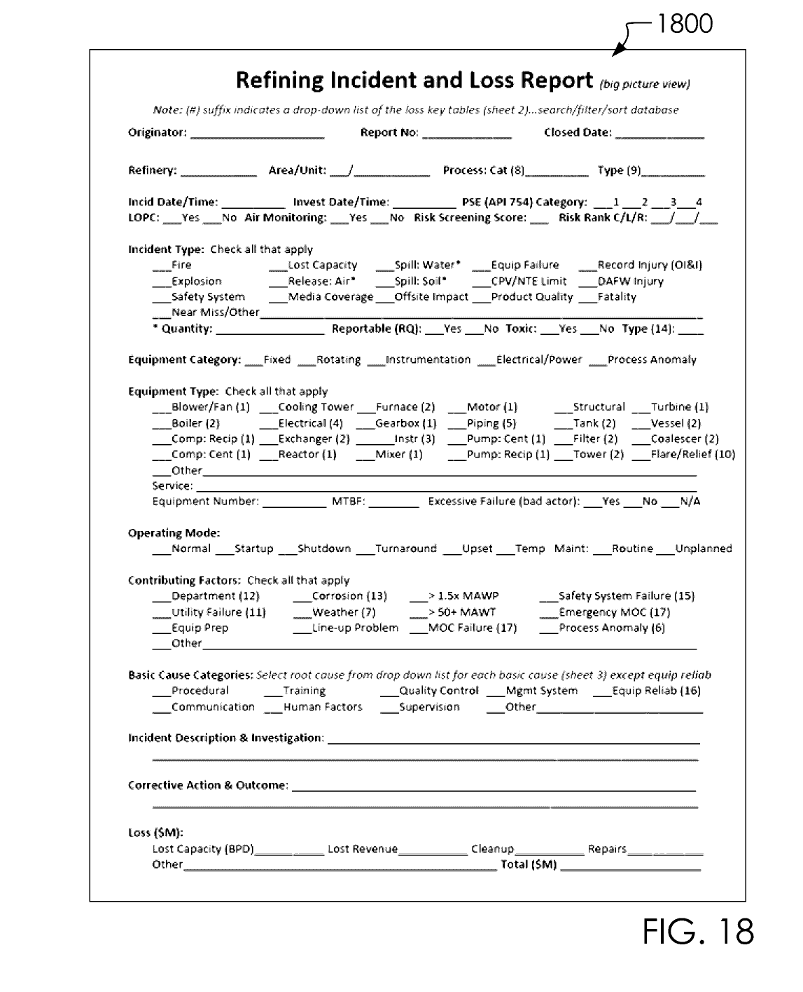

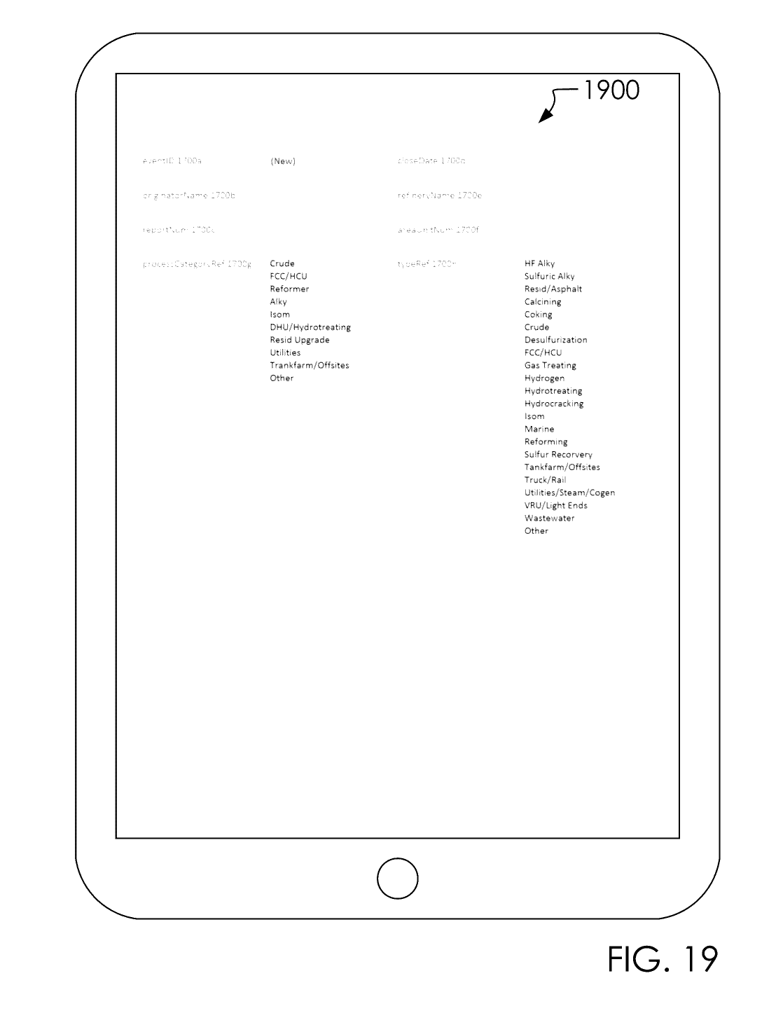

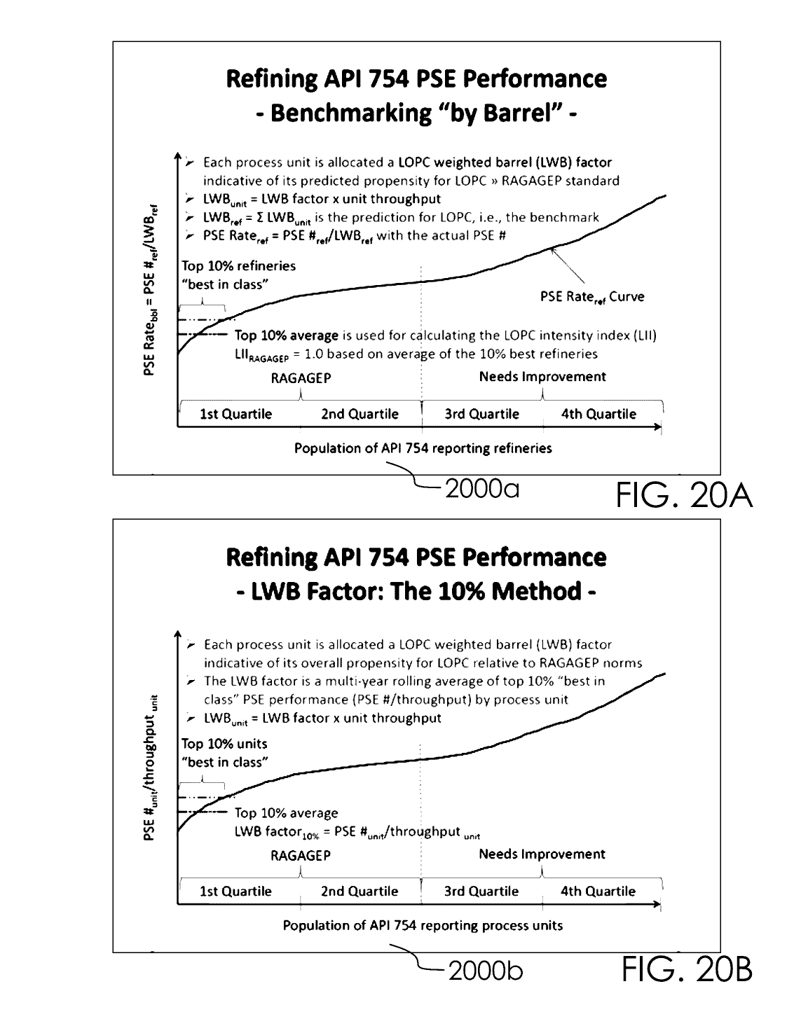

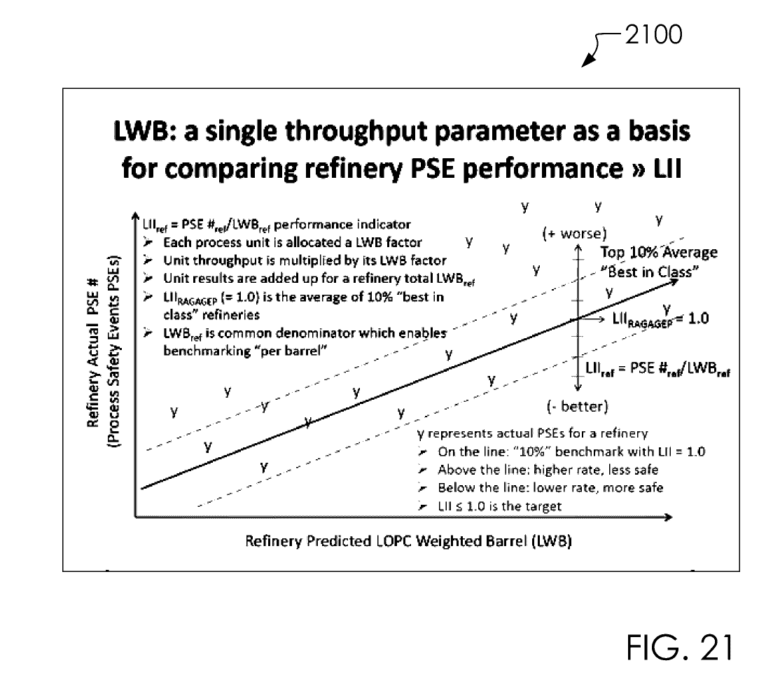

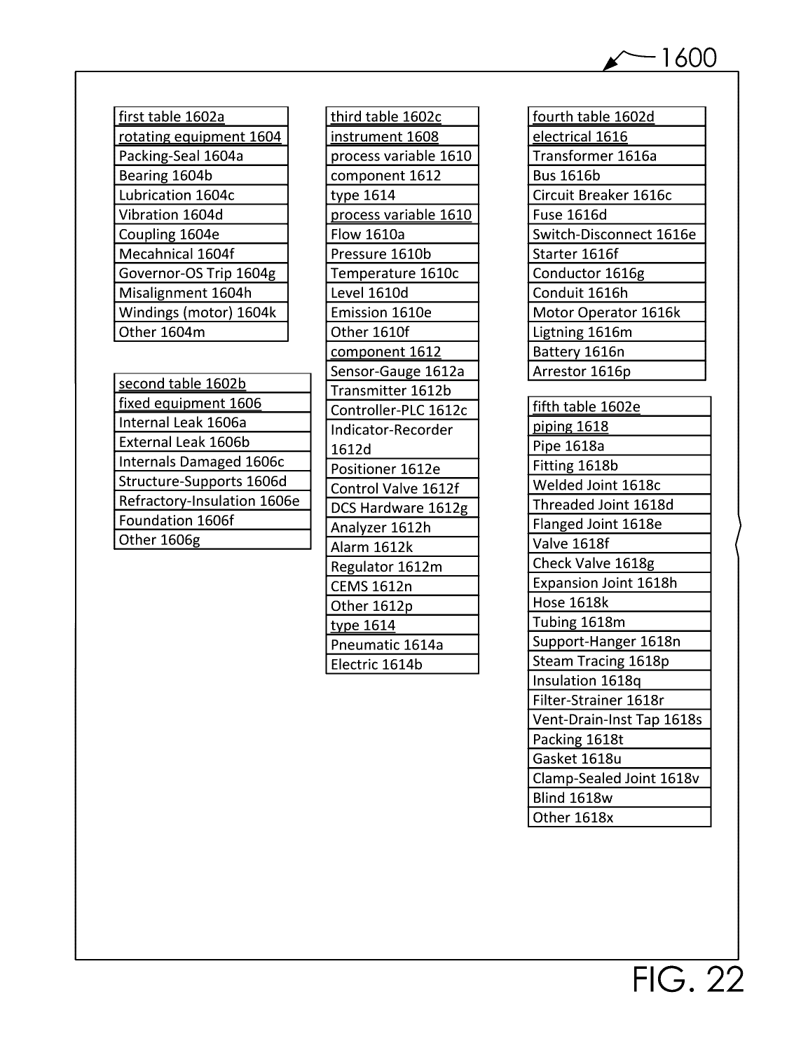

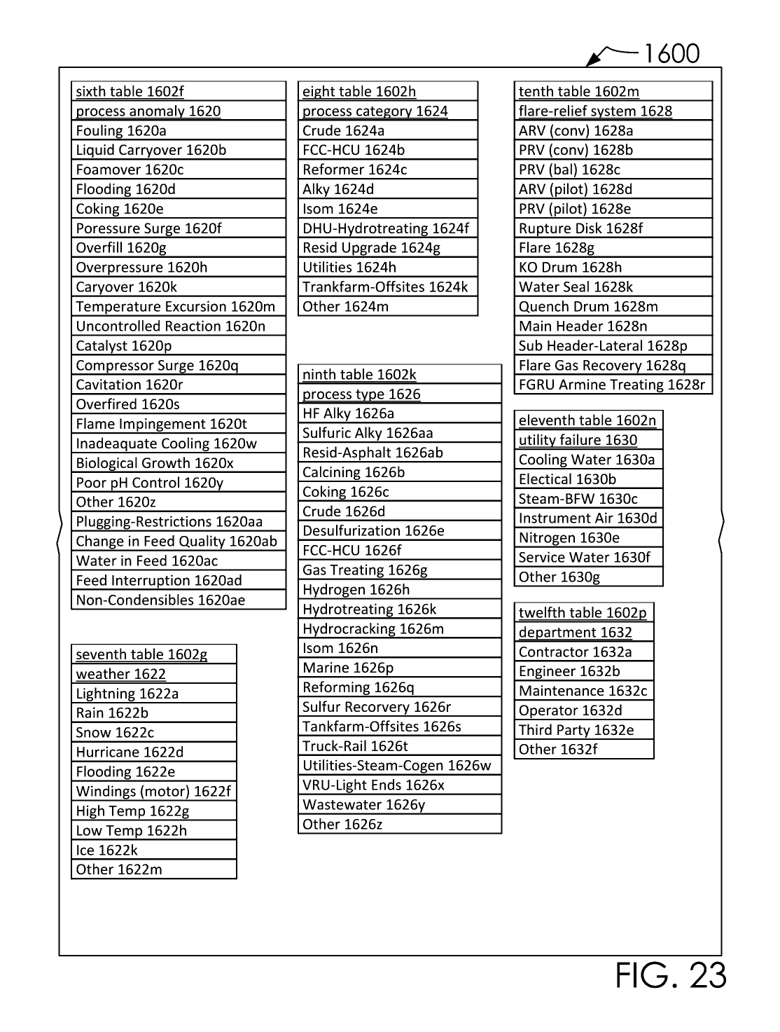

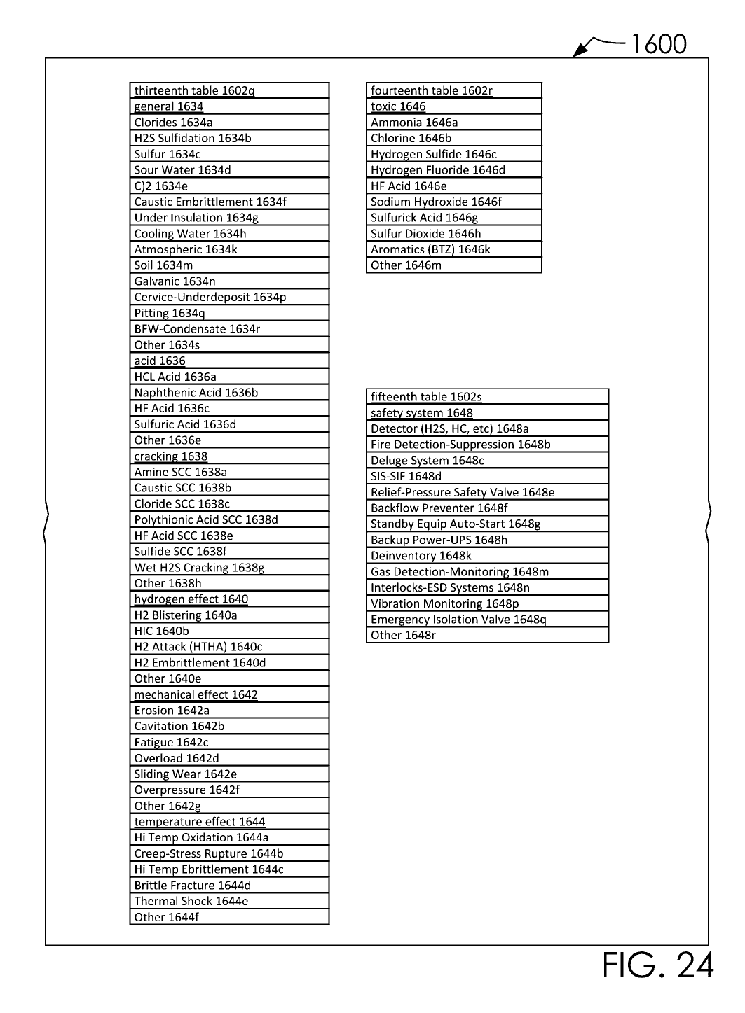

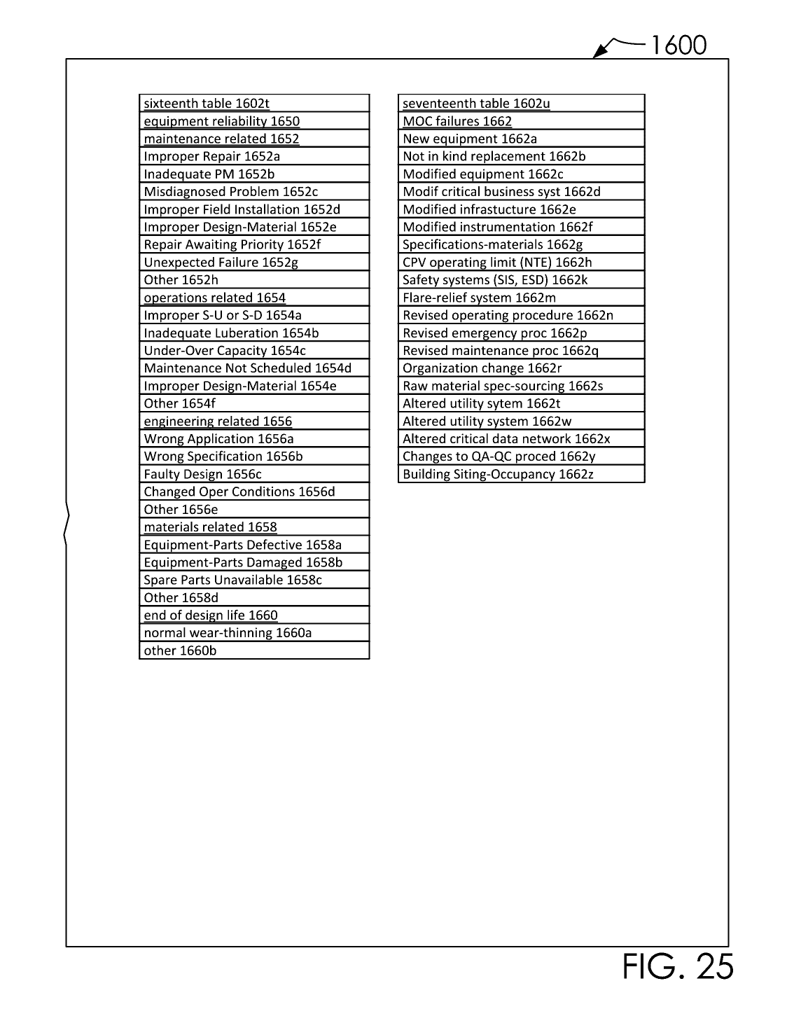

FIG. 9 illustrates a KIP analysis procedure 900.

FIGS. 11A, 11B, 11C, 11D and 11E illustrate procedural improvement analysis.

FIG. 12 illustrates an improvement procedure 1200.

FIG. 13 illustrates a data entry module for the system.

FIG. 14 illustrates a loss and incident flow diagram 1400.

FIG. 15 illustrates three tables in relationship to one showing the data relationships within the system as a system database 1502.

FIG. 16 illustrates a table showing enumerated options categorized into tables and categories; where these entries are later used within the system to encode incidents at an industrial facility being managed with the system.

FIGS. 17A and 17B illustrate a data relationship query 1700 and a subset of data within the system database 1520, and a query result table 1702 comprising portions related to “rotating equipment”, as illustrated.

FIG. 18 illustrates an incident report 1800 for paper use.

FIG. 19 illustrates a portion of an electronic incident report 1900 for use on a computer.

FIGS. 20A and 20B and 21 illustrate graphical data underlying the process.

FIG. 14 illustrates . . . The plan, do, check, act elements of the LOCMS management system

FIG. 15 illustrates . . . .

FIG. 16 illustrates . . . an incident and loss report key

FIG. 17 illustrates . . . Refining API 754 PSE Performance: Benchmarking “by Barrel”

FIG. 18 illustrates . . . LWB: a single throughput parameter as a basis for comparing refinery PSE performance >>LII

FIG. 19 and following are user interface images of the system for a software embodiment of this system.

### DETAILED DESCRIPTION OF THE INVENTION

Parts in this application include but are not limited to the following:
first network configuration 100
third computer 102c
one or more computers 102
first computer 102a
second computer 102b
second location 103b
first location 103a
third location 103c
one or more locations 103
printer 104
network 106
server 108
data storage 110
data storage 110a
mobile phone 201a
personal computer 201b
tablet 201c
screen 202
one or more input devices 204
one or more cameras 204c
trackball 204b
keyboard 204a
track pad 204d
home button 220
address space 302b
address space 302
address space 302c
address space 302a
address space 302d
processor 304
processor 304a
processor 304d
processor 304c
processor 304b
memory 306c
memory 306
memory 306b
memory 306d
memory 306a
communication hardware 308
communication hardware 308a
communication hardware 308b
communication hardware 308c
communication hardware 308d
device application 502
data records 504c
data records 504d
data records 504a
data records 504b
server application 506
procedural overview 600
system initialization step 602
first input 604
first process 606
second process 608
third process 610
standby procedure step 612
LOCM Repeating Process 700
begin process step 702
direct input step 704
maintenance mode 706
outside sources input step 708
diagnostic steps 710
optimization steps 712
work process steps 714
integrated management systems illustration 800
KIP analysis procedure 900
KIP analysis initialization step 902
first analysis step 904
second analysis step 906
third analysis step 908
fourth analysis step 910
fifth analysis step 912
end procedure step 914
system inputs diagram 1000
remote data sources 1020
EAM Platform 1022
workforce 1024
LOCMS modules 1026
fourth zone 1102d
second zone 1102b
first zone 1102a
third zone 1102c
one or more zones 1102
first site 1104a
one or more industrial sites 1104
third non-industrial zones 1106c
first non-industrial zones 1106a
second non-industrial zones 1106b
one or more non-industrial zones 1106
one or more danger zones 1108
second danger zone 1108b
first danger zone 1108a

Described herein is a Loss of Primary Containment Management System. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

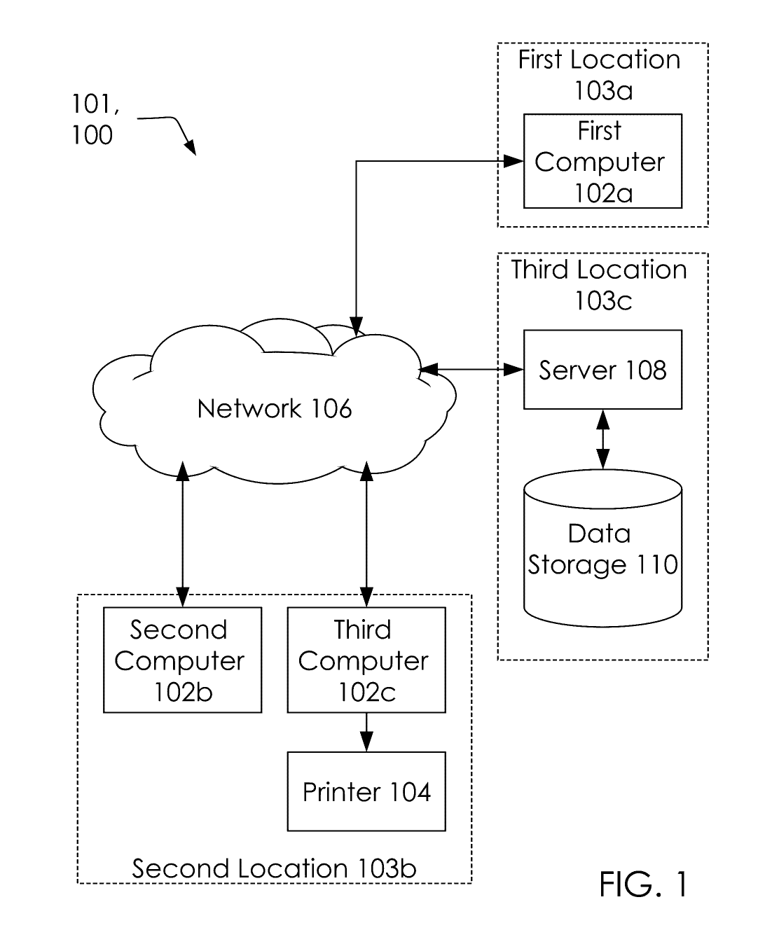

FIG. 1 illustrates a first network configuration 101 of a LOCMS system 100. In one embodiment, said LOCMS system 100 can comprise a one or more computers at a one or more locations.

In one embodiment, said one or more computers can comprise a first computer 102a, a second computer 102b and a third computer 102c. In one embodiment, said one or more locations can comprise a first location 103a, a second location 103b and a third location 103c. In one embodiment, said first location can comprise a field location. In one embodiment, said one or more computers can communicate on a network 106, which can connect to a one or more servers (such as a server 108). In one embodiment, a printer 104 can be hardwired to said first computer 102a (not illustrated here), or said printer 104 can connect to one of said one or more computers (such as said third computer 102c, illustrated) via network 106.

Said network 106 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed (interconnected via any suitable communications network).

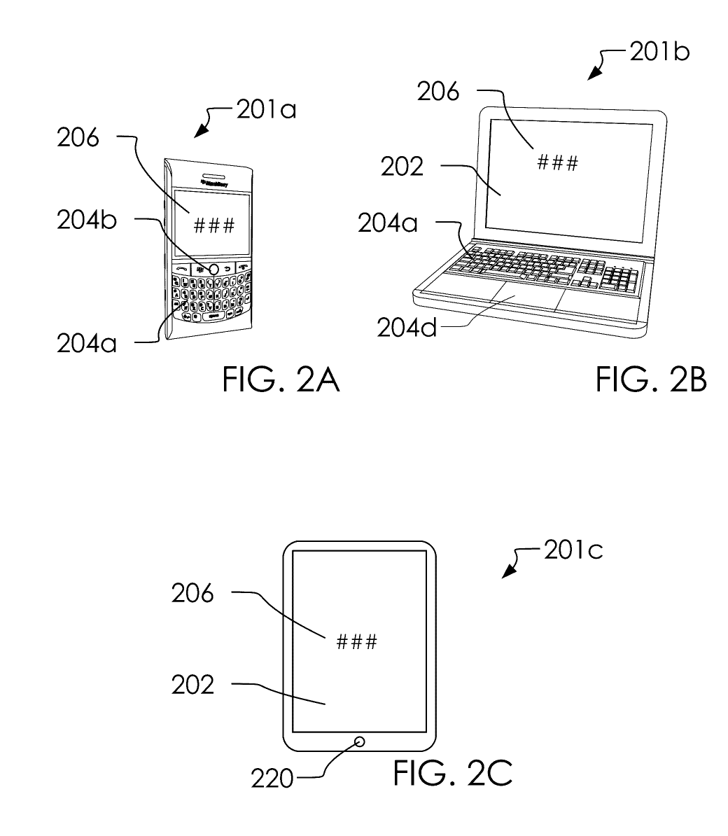

FIGS. 2A, 2B and 2C illustrate a perspective overview of a mobile phone 201a, a personal computer 201b and a tablet 201c.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 201b), desktop, workstation, server, mainframe, terminal, a tablet (such as said tablet 201c), a phone (such as said mobile phone 201a), and/or similar. Despite different form-factors, said one or more computers can have similar basic hardware, such as a screen 202 and a one or more input devices (such as a keyboard 204a, a trackball 204b, a one or more cameras 204c, a wireless—such as RFID—reader, a track pad 204d, and/or a home button 220). In one embodiment, said screen 202 can comprise a touch screen. In one embodiment, said track pad 204d can function similarly to a computer mouse as is known in the art. In one embodiment, said tablet 201c and/or said personal computer 201b can comprise a Microsoft® Windows® branded device, an Apple® branded device, or similar. In one embodiment, said tablet 201c can be an X86 type processor or an ARM type processor, as is known in the art.

Said LOCMS system 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices similar to said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar.

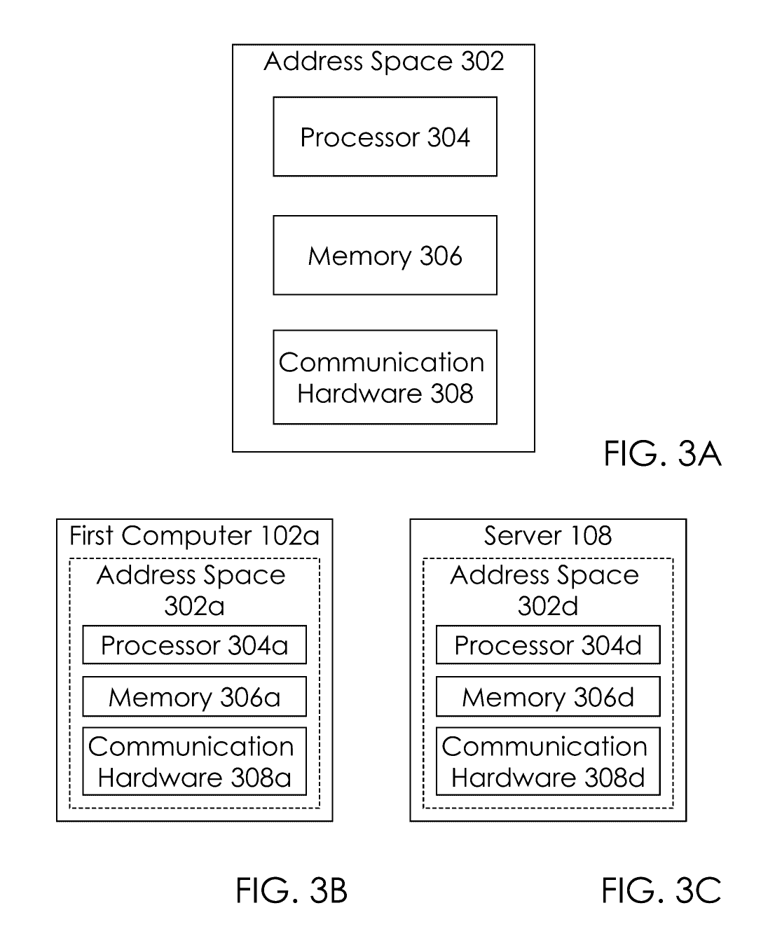

FIGS. 3A, 3B and 3C illustrate an address space 302 within said one or more computers, an address space 302a and an address space 302d.

Each among said one or more computers and said server 108 can comprise an embodiment of address space 302. In one embodiment, said address space 302 can comprise a processor 304, a memory 306, and a communication hardware 308. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required data 206 has been gathered for said data management system and method. In one embodiment, said data 206 can include data which said one or more computers can populate automatically, such as a date and a time, as well as data entered manually. Once a portion of gathering data has been performed said data 206 can be sent to said communication hardware 308 for communication over said network 106. Said communication hardware 308 can include a network transport processor for packetizing data, communication ports for wired communication, or an antenna for wireless communication. In one embodiment, said data 206 can be collected in one or more computers and delivered to said server 108 through said network 106.

In one embodiment, said first computer 102a can comprise said address space 302a, a processor 304a, a memory 306a, and a communication hardware 308a. Likewise, in one embodiment, said server 108 can comprise said address space 302d, a processor 304d, a memory 306d, and a communication hardware 308d.

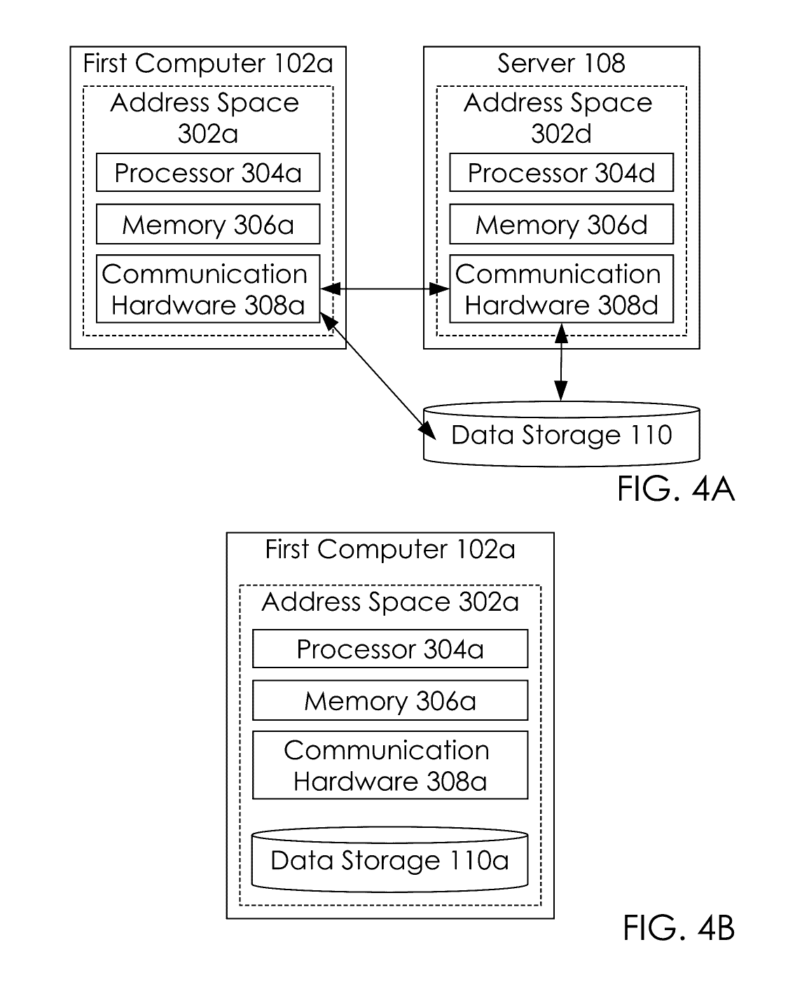

FIGS. 4A and 4B illustrate two embodiments for collecting and storing data with said LOCMS system 100; a first embodiment with a flow diagram between said first computer 102a and said server 108, and a second embodiment comprising of just said first computer 102a.

In the first embodiment, said communication hardware 308a and said communication hardware 308d can send and receive data to and from one another and or can communicate with said data storage 110 across said network 106. Likewise, in the second embodiment, data storage 110 can be embedded inside of said one or more computers as a data storage 110a, which may speed up data communications by said LOCMS system 100. In another embodiment, said data can be stored temporarily on said data storage 110a and later moved to said data storage 110 for backup and sharing purposes.

As illustrated in FIG. 4A, in one embodiment, said server 108 can comprise a third party data storage and hosting provider or privately managed as well.

As illustrated in FIG. 4B, said data storage 110 can be located on said first computer 102a, here labeled as said data storage 110a. Thus, said first computer 102a can operate without a data connection out to said server 108 while performing said system and method for field capture of data.

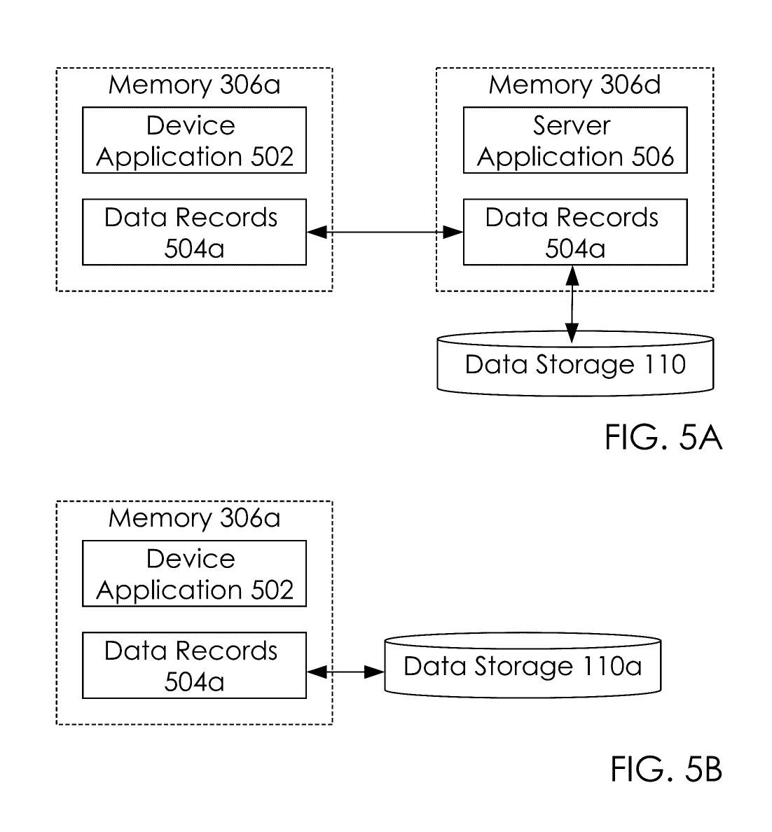

FIGS. 5A and 5B illustrate two examples of a flow diagram between said memory 306a and said memory 306d.

As illustrated in FIG. 5A, in one embodiment, said LOCMS system 100 can process said data 206 on said first computer 102a and/or said server 108. For example, in one embodiment, said memory 306a can comprise a device application 502 capable of generating a data records 504 from user inputs or, otherwise, processing said data records 504 delivered to said device application 502 from said data storage 110. In one embodiment, said data records 504 can be transferred between said device application 502 on said memory 306a of said first computer 102a and a server application 506 in said memory 306d of said server 108. In one embodiment, said server 108 can be useful for processing said data 206, as is known in the art. As illustrated in FIG. 5B, in another embodiment, said server 108 can be removed from the flow diagram entirely as said memory 306a is capable of processing said data records 504 and/or said data 206 without the assistance of said server 108.

Loss of Primary Containment “LOPC”

LOPC, per the Center for Chemical Process Safety, refers to an unplanned or uncontrolled release of material from primary containment, including non-toxic and non-flammable materials (e.g., steam, hot condensate, nitrogen, compressed CO2 or compressed air).

This one embodiment delineates the culture of management system design, implementation, and sustainability as it relates to the ultimate concern of any process safety management program, i.e., the loss of primary containment (LOPC). This management system process focuses on the four key business drivers of risk, regulatory, operations, and profits, and involves several distinct business methods involving people, processes and tools/technology. At the center of the management system is the unique design and implementation of metrics and KPIs created from data lifted and aggregated from an enterprise asset management platform (EAM).

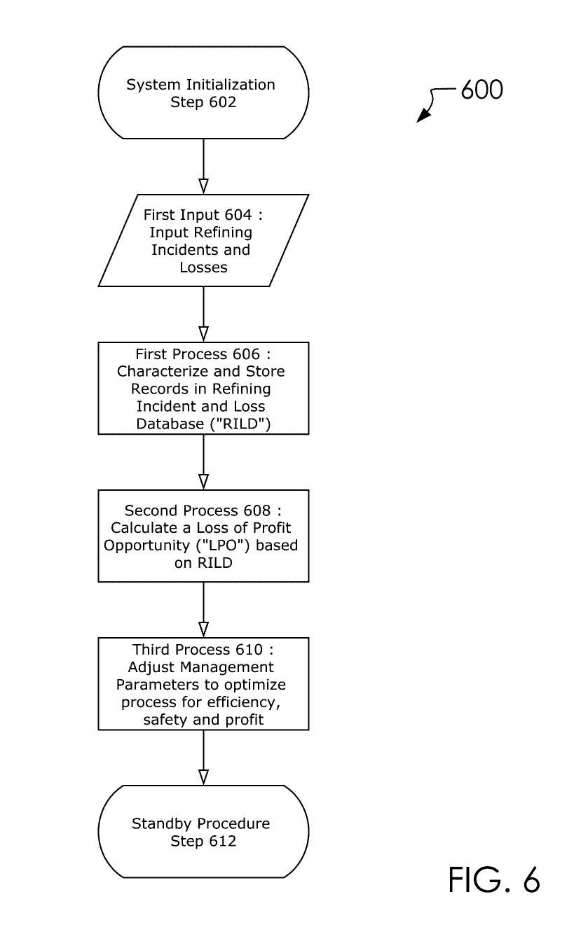

FIG. 6 illustrates a system procedures overview 600.

Said system procedures overview 600 can comprise steps and inputs 602-612 as enumerated above and listed in FIG. 6.

In one embodiment, a key to this approach is a refining incident and loss database and performance trending methodology. In one embodiment, said refining incident and loss database (“RILD”) can calculate a lost profit opportunity (“LPO”).

The highly publicized incidents at BP Texas City in 2005, Tesoro Anacortes in 2010, and Chevron Richmond in 2012 all happened not due to a failure of equipment, instrumentation, facility siting, operator, procedure, communication, supervision, or training, but rather a failure of all those things together, i.e., a management system failure.

The BP, Tesoro and Chevron incidents are now driving the reexamination of the PSM rule by the US regulatory community. The US Chemical Safety Board (CSB) has taken notice that US Oil & Gas industry losses are highest among any industrial sector, and that the US Refining industry accident rate is 3 to 4 times higher than in Europe (Moure-Eraso, 2014).

The PSM rule and its allegedly “less rigorous regulatory framework” are quickly falling out of favor with regulators. As such, the attributes of the “Safety Case” and ALARP regulatory regime currently in use throughout the United Kingdom, Australia and Norway are now being advocated by the CSB. And even more notable is California's 2014 proposed regulation for inherently safer design (ISD), an initiative which was endorsed by then-CSB chairman Dr. Moure-Eraso, with him suggesting that other states should do the same.

ISD has been hotly debated for years, and would require that risk be reduced to the greatest extent possible with the selection and implementation of changes in chemistry and/or a change to process variables, e.g., reduction in pressure, temperature, flows, etc. Unmistakably, this would be taking the petrochemical industry and its PSM process safety approach from performance-based to prescriptive.

Yet, before opting to prescriptively rewrite the PSM rule, this disclosure suggests that there is a performance-based option which is more sensible, productive and achievable in the short term, and that is a focused metrics-driven management systems approach. Such an approach also embodies the core principles of the PSM rule and is consistent with the findings and recommendations of the 2007 Baker Panel Report (2007 Baker Panel focus areas and opportunities for improvement) (hereafter the “Baker Report

[symbol]

Baker Panel Findings and Opportunities for Improvements, in review, has three categories of recommendations; namely, the PSM systems, evaluation steps and cultural changes.

First, the Process Safety Management Systems have several components: (i) Process risk assessment and analysis, (ii) Compliance with internal process safety standards, (iii)

Implementation of industry good engineering practices—Engineering design practices and associated training are in place and translate industry into specific ‘how to’ design guidance and application standards, (iv) Process safety knowledge and competence, and (v) Effectiveness of corporate process safety system—Management systems are effective and successful m preventing incidents (PSE's).

Next, the Performance Evaluation, Corrective Action, and Corporate Oversight have these components: (i) Measuring process safety performance, (ii) Incident and near miss investigations, (iii) Process safety audits, (iv) Correction of identified process safety deficiencies—Repeat findings are addressed suggesting that ‘true root causes’ are being identified and corrected, (v) Effective use of findings from operating experiences, process hazard analyses, audits, near misses, and incident investigations to improve operations and systems—Performance data and indicators are effectively used to drive continuous improvement in process safety and risk management systems (e.g., the risk of major incident related to LOPC data . . . Baker Report), and (vi) Adequate management and corporate oversight.

Finally, the Corporate Safety Culture procedure requires that any one or all of the following management system elements might be scrutinized in the event of an incident relative to the opportunities noted above: (i) Effectiveness of process safety leadership, (ii) Adequacy of employee involvement and empowerment, (iii) Adequacy of resources and positioning of process safety capabilities, (vi) Effective ness of incorporation of process safety into management decision-making, and (v) Common, unifying process safety culture.

It would seem that the Baker Report is prompting us to revisit the PSM rule for intent and direction as well as the proper administration of the PSM rule, i.e., the effective application of a management systems approach to continuously improving our process safety environment and culture. After all, the authors of PSM took great pains to make it a performance-based standard for a reason (i.e., prescriptive is inherently inferior), so let's not give-up on that now.

With promulgation of the PSM Standard 29 CFR 1910.119, OSHA mandated that a management system comprised of several well-defined elements be established “for preventing or minimizing the consequences of catastrophic releases of toxic, reactive, flammable, or explosive chemicals.” The Process Safety Information (PSI) element of the PSM rule states “the employer shall document that equipment complies with recognized and generally accepted good engineering practices” (or “RAGAGEP”).

Although OSHA does not explicitly use the term continuously improving in their regulatory standards, they use equivalent terms such as accurate, complete, clear and on-going. For example, in the Appendix C compliance guidelines of 29 CFR 1910.119, OSHA uses the term “complete and accurate” in lieu of “continually improving.” Likewise, for the Mechanical Integrity element of 29 CFR 1910.119, OSHA uses the term “on-going” to describe the expectation to continually improve.

Recent incidents and enforcement actions demonstrate OSHA's expectation for operating plants to maintain a continually improving PSM process. In 2007, OSHA initiated a special enforcement initiative (OSHA's National Emphasis Program [NEP]) specific to refineries and chemical plants. Of the citations issued, many involved missing, inaccurate and incomplete process safety information.

Furthermore, process safety design integrity and reliability vs. RAGAGEP conformity is assessed annually in ever increasing detail for participants of OSHA's Voluntary Protection Program (VPP). Clearly, it is OSHA's expectation that operating plants have a continuously improving management systems process for ensuring the complete, accurate, clear and on-going integrity of process plant design and operations.

Besides, in the interest of social responsibility, it is just good business to develop a management system which not only enhances safety and environmental protection, but augments asset protection as well. Unmistakably, safety and environmental stewardship are of paramount importance, but asset protection, business continuity and public image also have vital significance in any business environment.

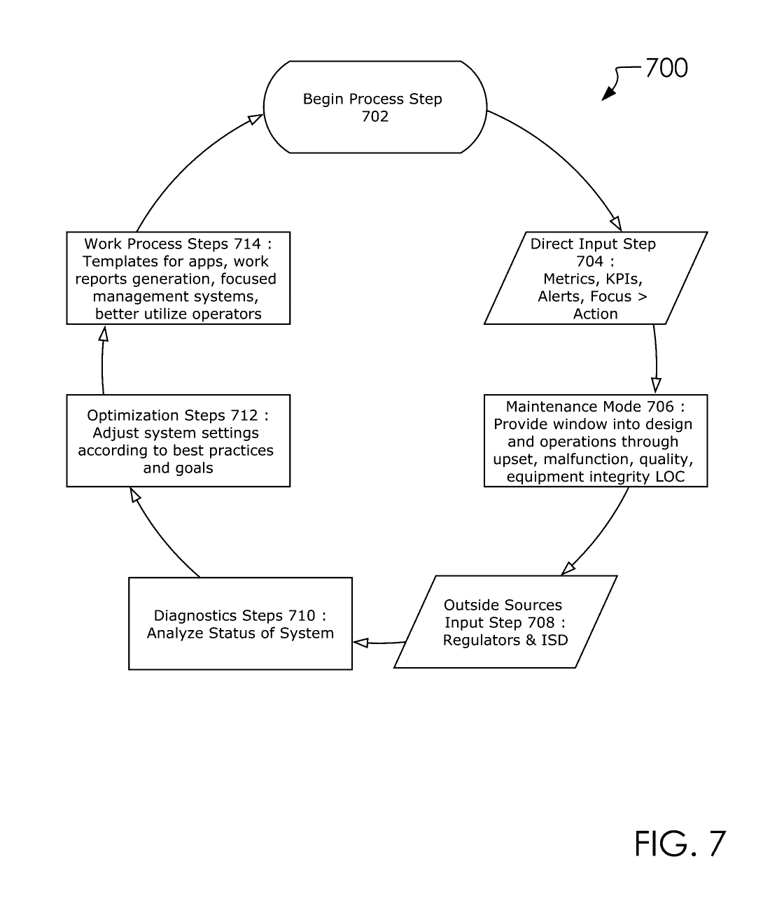

FIGS. 7-10 illustrate the who, what, when, where and how of doing just that with a focused, metrics-driven LOPC Management System (“LOCMS”).

Of course, knowing what data to capture and display is essential to proper metrics development and analysis, and the ensuing derivation of key performance indicators (KPIs).

Mechanical integrity and LOPC have come under particularly intense scrutiny by OSHA since promulgation of the PSM rule, with several enforcement actions citing missing, inaccurate and incomplete PSI (damage mechanisms [FIG. 3] and corrosivity data) relative to equipment operation, inspection and repair practices. In the crosshairs is the proper management of damage mechanisms and “Integrity Operating Windows” (IOWs). And alongside OSHA, the EPA has joined in by invoking the Clean Air Act with RMP citations as well as environmental enforcement actions mandating operational enhancements and costly capital improvements. So, it is clear that this double barrel surge by way of OSHA and EPA has arrived and is progressing rapidly forward.

Damage mechanisms can comprise amine corrosion, ammonium bisulfide, ammonium chloride, caustic, hydrochloric acid, high temp h2s, hydrofluoric acid, naphthenic acid, dead-leg corrosion, fatigue—various, soil corrosion, creep stress rupture, phosphoric acid, sour water corrosion, sulfuric acid, stress corrosion cracking (polythionic, amine, wet H2S, hydrogen), H2 attack, HTHA, embrittlement (caustic, sigma phase, brittle fracture, 885° F.), and metal dusting. However, any list of damage mechanisms is incomplete without mechanical failure mechanisms.

Furthermore, the PSM rule and its allegedly “less rigorous regulatory framework” are quickly falling out of favor with regulators. As such, the attributes of inherently safer design (ISD) are now being advocated by the CSB. Unmistakably, this would take the Oil & Gas industry and its PSM approach from performance-based to prescriptive. Yet, before opting to prescriptively rewrite the PSM rule, This disclosure suggests that there is a performance-based option which is more sensible, productive and achievable in the short term, and that is a focused metrics-driven management systems approach.

There is no doubt that profit is the principle motive behind all of business, and that would include the business of refining process safety. Quite frankly, too many refinery managers look at process safety as a cost of doing business, and that is just a modern day reality. And as such, justification for process safety expenditures involves a risk versus reward calculation, i.e., consequence versus likelihood of a process safety event occurring. The more progressive best practice companies will admit that, in the final analysis, it is just good business to develop management systems which not only enhance safety and environmental protection, but augment asset performance management, optimization and protection as well.

Our industry can be even more critical and innovative in responding to LOPC incidents by improving data and metrics relative to equipment inspection, maintenance, design and overall systems management. Historical operations, reliability and maintenance data can be better utilized and managed with analytical tools and performance metrics to determine needs, risk exposure, provide direction, and address opportunistic reliability issues. This would certainly include a much more critical focus and deep-dive analysis of API 754 process safety event LOPC metrics relative to damage mechanisms, operating envelopes, and consequences of deviation, procedures, design and training. As is, API 754 is of limited usefulness as a meaningful tool for process safety performance trending, optimization and benchmarking.

FIG. 7 illustrates a LOCM Repeating Process 700.

Said LOCM Repeating Process 700 can comprise the steps and parts 702-714 as illustrated.

This disclosure is alluding to is a focused, metrics-driven management system approach addressing damage mechanisms contributing to LOPC. When considering a performance improvement program in this highly regulated process safety environment, four key business drivers should first be considered, i.e., risk, regulatory, operations, and profits. Then, building a focused LOPC management systems process around those four drivers involves a unique management system structure of people, processes and tools/technology. Consider again FIG. 7 and the circular procedure for improving said 100/through a unique management system structure of people, processes and tools/technology.

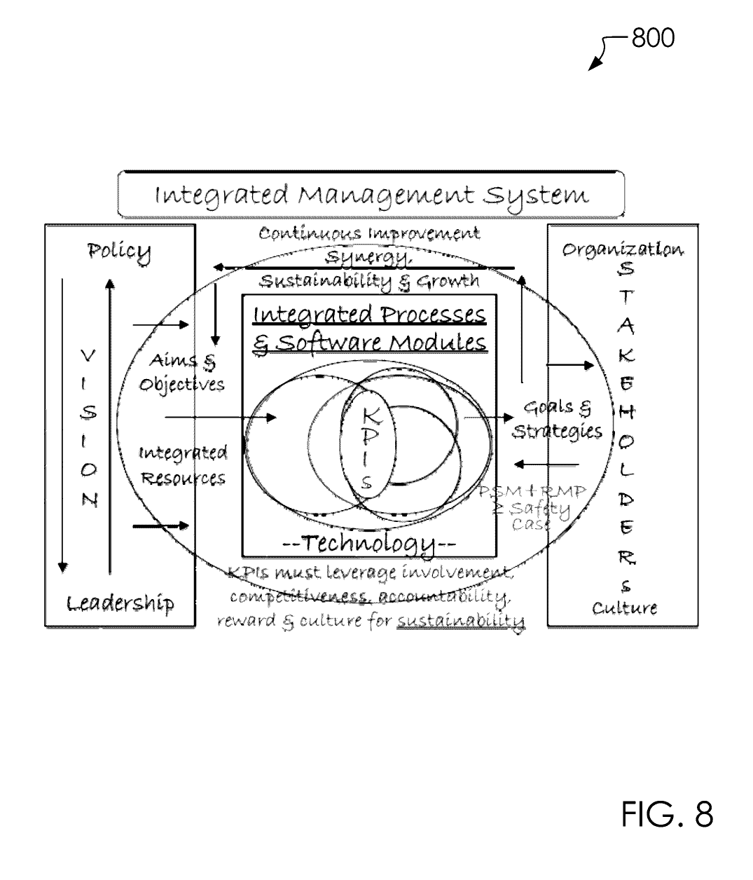

FIG. 8 illustrates a summary of KPI development and improvement (a integrated management systems illustration 800).

Of course, knowing what data to capture and display is essential to proper metrics development and analysis. The idea is to tap into the data rich potential of an enterprise asset management (EAM) system, and from those data and informational structures extract the 20% of data that 80% of operators, engineers, managers and execs want to see, with the challenge being identifying that 20% of key information, or KPIs.

KPI's are the 20% of data that 80% of operators, engineers, managers and execs want to see.

As for KPIs, there are two primary objectives of most refining business strategies, and that is reducing costs and improving equipment reliability. Two key indicators used to evaluate manufacturing cost effectiveness are mechanical availability and maintenance costs as a percent of replacement asset value (RAV). It is widely accepted by manufacturing companies that world class manufacturing performance means operating at greater than 97% mechanical availability and spending less than 2% on maintenance as a percent of RAV.

In order to achieve such “best in class” targets, tools must be used to analyze and trend performance relative to those measures, and employ various deep-dive methods and indicators which drive toward root causes of inadequate performance. To that end, a process optimization methodology utilizing root cause failure analysis (RCFA) should be utilized to reveal process safety opportunities as well as quantify economic impacts (lost profit opportunity LPO) of equipment anomalies, LOPC incidents and upset/malfunction operating conditions. Such a RCFA approach is key to analyzing and trending cost minimization, driving asset/process optimization and maximizing process safety performance in the refining industry.

Central to the growth and continuous improvement of those three elements will be the proper design and implementation of metrics and KPIs. It will be the institutionalization of KPIs and the subsequent reporting and action planning process which drives the continuity and sustainability of the plan-do-check-act rudiments of this management systems approach.

The PSM standard is exceptional in its vision, design and implementation, but it could have been made better by the inclusion of metrics and KPIs. As is often said, “if it can't be measured, it can't be managed,” and is likely a reason why so many process safety management system programs have failed to grow and measure up to industry best practices as well as OSHA expectations.

KPIs are the critical life's blood of a properly designed management system in that they institutionalize processes and drive accountability, which in turn provides for continuity and sustainability. An effective KPI system and data mining process takes into consideration business drivers, success factors, targets, performance measures and improvement actions. But knowing which metrics should be funneled into KPIs is the challenge.

Again, it would now seem that API 754 was written only to gauge the ‘high level’ effectiveness of PSM programs. And yet, opportunity still remains for developing more in the way of focused metrics which further drive performance improvement in areas like loss of containment, equipment reliability, design and operation, among others. And correspondingly, the CSB has characterized the shortcomings of API 754 (Gomez, 2012) as follows: (1) Tier 1 and 2 numbers are lagging indicators and thus of limited usefulness as performance indicators; (2) Statistical power of likely small numbers of Tier 1 and 2 events is insufficient to detect effect; (3) Tier 3 and 4 events are leading indicators which are reflective of process failures, and yet are not publicly reported and utilized for industry trend analysis and benchmarking comparisons; and (4) Employee participation was insufficient in the development process and thereby lacking in a broad-based consensus.

What I am suggesting is that we as an industry can be even more critical and innovative by utilizing historical operations, reliability and maintenance data in analytical tools and performance metrics to create a competitive environment for improving plant reliability and profitability. I stress the word ‘competitive’ in that this plan-do-check-act process will drive itself and grow by fostering a healthy and productive incentive among stakeholders for continuous improvement in reliability, profitability, and most importantly, process safety.

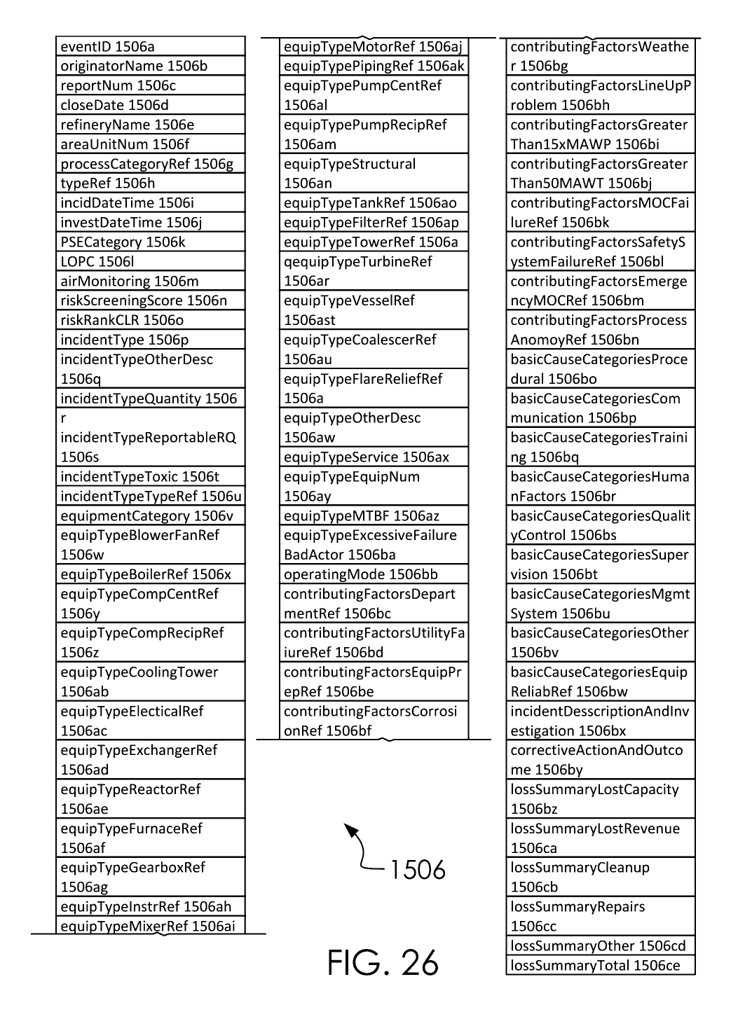

FIG. 10 illustrates a system inputs diagram 1000 between a workforce said device application 502.

Said system inputs diagram 1000 can comprise a remote data sources 1020, a EAM Platform 1022, a workforce 1024 and a LOCMS modules 1026, as illustrated.

With KPIs, the idea is to tap into the data rich potential of an enterprise asset management (EAM) system. And again, from those data and informational structures is extracted the 20% of data that 80% of operators, engineers, managers and execs want to see, with the challenge being identifying that 20% of key information. And beyond that, further consideration is necessary for the more refined development of KPIs which then provide the need-to-know requirements of stakeholders at a ‘dashboard’ level of awareness.

With KPIs, the idea is to tap into the data rich potential of an enterprise asset management system (EAM).

What so many KPIs fail to do is drill down deeply enough to facilitate the identification of basic and root causal factors associated with problem solving for optimal performance. And there can be too many these focused metrics, with the pitfalls being much the same as usability problems associated with multiple alarms annunciating during a process unit upset, commonly referred to as alarm flood. And just as with too many alarms, poorly designed alarms and improperly set alarm points, metrics flood and confusion can set in and negatively impact the problem solving process.

FIG. 9 illustrates a KIP analysis procedure 900.

Said KIP analysis procedure 900 can comprise steps 902-914, as illustrated.

Proper development, implementation and management of metrics and KPIs should involve many of the same concepts utilized in alarm rationalization and management, and is really more of an art form than many realize. It requires critical thinking and strategic design aptitude which draw on frontline-to-exec level appreciation for what good looks like. And what good looks like is what the LOCMS design has in mind for a loss of containment focused management systems process.

The proper development, implementation and management of metrics and KPIs is really more of an art form than many realize.

Too often, the process of data gathering and metrics reporting is more about presentation than substance, and lacks real problem solving and process optimization potential. The metrics and KPIs of LOCMS are specifically designed for problem solving performance improvement issues at the basic and root cause levels, and built around the business drivers of risk, regulatory, operations, and profits (FIG. 8).

FIGS. 11A, 11B, 11C, 11D and 11E illustrate procedural improvement analysis.

The metrics and KPIs of LOCMS are built around the business drivers of risk, regulatory, operations, and profits.

As previously mentioned, PSM was conceived out of a management system mentality of a plan-do-check-act cycle with continuous improvement at its core. The focused, metric-driven management system of LOCMS follows this same model and function.

FIG. 12 illustrates an improvement procedure 1200.

What so many management system development initiatives fail to do is involve a three phase design and implementation process in determining the following: where are we now, where do we want to go, and how are we going to get there. Further, what so many management system development initiatives fail to do is involve a three phase design and implementation process: where are we now, where do we want to go, and how are we going to get there.

Such management system approaches have been successfully applied to product quality, asset integrity and protection, process optimization, equipment reliability, and various performance improvement initiatives. Establish performance targets, measure progress and take action using focused metrics and KPIs, i.e., any kind of deficiency relative to LOPC, quality, lost profit opportunity, damage mechanisms, seal failures, chemical additive programs, vibration failures, lubrication failures, etc. (1) Deficiencies by incident type: fire, explosion, safety system, lost capacity, release, spill to water, spill to soil, equipment failure, CPV/NTE limit, product quality, offsite impact, recordable injury, DAFW injury, fatality, near miss; (2) Deficiencies by equipment category: fixed, rotating, instrumentation, electrical/power; (3) Deficiencies by equipment type: columns, compressors, drums, filters, heat exchangers, fired heaters, boilers, piping, pumps, reactors, tanks, turbines, vessels, other; (4) Deficiencies by utility: instrument air, cooling water, power distribution, power supply/3rd party utility, process water, nitrogen, fuel gas, natural gas, heat tracing; (5) Deficiencies by department: operations, maintenance, engineering, contractors; and (5) Deficiencies by anything: List goes on and on . . . .

API 754 has already made the case for establishing common metrics across industry, yet it fails to capture, compare and share the more revealing Tier 3 and 4 PSE data (only high level Tier 1 and 2 PSEs). By highlighting and benchmarking these “below the surface” PSE findings by company size, type, and peer group, specific performance improvement opportunities can be better assessed in order to further enhance RAGAGEP and regulatory conformance.

What does good (or “where we want to go”) look like and how do we plan a path forward. Critical focus on management systems design and implementation: people, processes, tools/tech. Strategic/economic focus on gaps, soft spots and critical systems within operations, maintenance and engineering organizations plus corporate.

Content: the 20% of data 80% of stakeholders want to see (strategic and customizable KPIs, data maps/views, scorecards, dashboards, reports, data portals, alerts, analyses, trends). Make anyone with a smart device on alert 24/7.

Understanding and leveraging nuances of culture: (1) Plant environment (operations, maintenance, engineering, corporate); (2) Cost/safety prioritization; (3) Internal competitiveness/silos.

Integrating with MI (and RBI) and other PSM programs, leveraging IT and maximizing synergies.

White paper/presentation blitz and roadshow: (1) AIChE CCPS, MKOPSC International Symposium, API, AFPM [formerly NPRA], NACE, etc; (2) Other plant locations/corporate. Get regulators on-board: CSB, OSHA, EPA.

Enhance practices to address most (if not all) noted industry trends and drivers (since they all work best together): leverage existing processes: (1) Utilize metric driven management systems with tiered KPIs/dashboards, with risk management and RBI/PSM strategies not far behind: a big environmental driver too; (2) Walk before running by beginning with metric driven LOPC minimization health check initiative (most bang for the buck): by tweaking and maybe adding a little; (3) Include ISO 55000 structure and certification (corporate HQs love plant certifications like ISO quality and RCMS); (4) Partner with OSHA to add this to OSHA VPP Star certification as Safety Case example: institutionalize within industry.

Integrate with existing assets, programs and systems: (1) Design to involve no new manpower, only new processes and tools; (2) Compatibility with 3rd party applications, software and systems.

Leverage synergies/overlaps with PSM, equipment inspection and reliability programs (RBI API 580/581), especially damage mechanisms (API 572) and IOWs (API 584): (1) LOPC minimization specific programs for mechanical integrity, PHA, MOC, incident investigation, procedures, PSI, PSSR, etc., and other PSM elements; (2) Assess mechanical integrity pressure/temperature/flow exceedances via fitness-for-service (FFS API 579).

Tap into cultural norms and nuances: (1) Design for a business perspective on everything, including process safety: strong regulatory driver; (2) Tightly integrate strategy and tactics with business processes to be synergistic and self-sustaining: invert the pyramid (bottom up); (3) Ensure organization and systems are designed to enable execution of business processes: must be compatible with existing; (4) Design for employee involvement for buy-in at all levels, and make it competitive; (5) Business-based metrics/KPIs: risk, regulatory, operations, profits; (6) Get KPIs in hands of those closest to the work, i.e., those most able to affect change: the front-line (those with most subject matter expertise and cultural/organizational savvy): this is can be tricky; (7) Connect enterprise performance measurement with economics, budgets, performance reviews, and bonuses: corporate execs love this.

Integrate existing IT structure and software: synergies: (1) ITPM programs; (2) AIM programs; (3) PSM software; (4) SAP platform; (5) 3rd party software; (6) Digital control systems; (7) Process instrumentation; (8) LIMS (laboratory) info management system; (9) CMMS computerized maintenance management system.

Design to drive sustainability (training, auditing, certification, profits). Provide for enterprise discoverability and sharing: leverage big data IT. Pilot with well-matched plant(s): fast-track: (1) Choose at least two sites for competitive excellence; (2) Strong senior management support is key to overall success.

Enterprise LOPC Manager.

‘One-Stop’ ePSD Portal safety and risk manager >>PSI. LOPA for LOPC: bridging PHA and various RCFA efforts. Risk Profiling/Mapping across enterprise (f/N approaches). ‘Health Check’ LOPC minimization real-time monitoring. Debottlenecking flexibility analysis and optimization. LOPC Management/Minimization Plan management system. Mechanical Integrity ITPM/RBI operation protocols, reliability. Industry Comparative Benchmarking (a la Solomon Assoc). Management of Change impact alerting via Smart PSI. Auditing and Certification for OSHA VPP Star renewal, RC. Training for performance assurance. Root Cause Analysis: Metric design(able), analysis & trending. Refining Incident and Loss Database.

So, where is your risk?

Safety critical systems identification, control and management. Systems >1.5×MAWP (including overfill): by design and omission: (1) Degree of overpressure by PRA scenario (especially reverse flow); (2) Ratio of hi/lo pressure differential by system: inherent risk of process technology; (3) Categorize by leakage severity as multiple of MAWP: medium at 1.5 to 2.0, high at 2.0 to 3.5, rupture at >3.5 (per API 581 Table 7.13 & 1998 Code Case); (4) ‘Corrected hydrotest’ to exclude corrosion allowance.

PRVs to atmosphere (ARVs): EPA strongly recommending elimination of ARVs and may issue NOV for each activation: (1) Liquid overfill (including remote contingency); (2) Vapor dispersion; (3) Auto-ignition.

What are your policies and practices concerning: (1) Development, implementation, monitoring, recording, and modification of operating guidelines for process equipment subject to damage mechanisms; (2) Evaluation and selection of materials for process equipment subject to damage mechanisms; (3) Development and implementation of inspection programs, protocols, standards, and methods for process equipment subject to damage mechanisms; (4) Monitoring and controlling damage mechanisms; (5) Performing hazard assessments in the review of operating procedures.

What is your involvement with industry trade groups, other companies, and best practice consultants? What has been your experience with damage mechanisms, and is there a refining-wide process for sharing lessons-learned. To what degree are you conforming with RAGAGEP and standardizing LOPC programs? How do you compare with industry? Is damage mechanism PSI being utilized in the PHA process? How do you manage your risk?

Key MI Principles and Essential Elements: (1) Adopt a formal LOPC vision and strategy that apply across all of Refining: standardization; (2) Consistent with LOPC RAGAGEP, fully develop and implement damage mechanisms and IOW PSI: RAGAGEP conformity; (3) Integrate damage mechanism and IOW PSI with the PHA process: an industry-leading PSM best practice; (4) Manage cross-organizational involvement and interaction with RBI, damage mechanisms, and IOW RAGAGEP: a management system; (5) Analyze data for proactive/preventive inspection and maintenance: metrics; and (6) Staff and maintain a high level of expertise through certifications.

All sites adopt a new Refining-wide LOPC philosophy: (1) Incorporating operational limits (API 584: IOW), inspection (API 580: RBI) and damage mechanism/corrosion maps (API 571) PSI into the LOPC process. API 584, 580 & 571 supplement one another; Partner with an OSHA recognized, best practice consultant in fully developing LOPC programs per API and other RAGAGEP.

Introduce LOPC damage mechanism and IOW PSI as standalone PHA ‘study modules’ like relief, EIV and SIS reviews.

Phase implementation to address immediate LOPC needs.

Empower a higher level manager to lead and staff initiative: (1) Empower to ensure participation, cooperation and responsiveness; (2) Involve people ‘closest to the work’ for quality, ownership & buy-in; (3) Engage resources including Technologists, Specialists, PSM Coordinators, hourly as well as reps from all impacted organizations. And finally, handle program development like a project.

Generally speaking, profits are the motive behind all of business, and that includes the business of refining process safety. There are two primary objectives of most refining business strategies, and that is reducing costs and improving equipment reliability for optimum asset performance. And as such, process safety is a cost of doing business which involves a risk versus reward calculation, i.e., consequence versus likelihood of a process safety event.

FIG. 13 illustrates a data entry module for the system.

FIG. 14 illustrates a loss and incident flow diagram 1400.

FIG. 15 illustrates three tables in relationship to one showing the data relationships within the system as a system database 1502.

FIG. 16 illustrates a table showing enumerated options categorized into tables and categories; where these entries are later used within the system to encode incidents at an industrial facility being managed with the system.

FIGS. 17A and 17B illustrate a data relationship query 1700 and a subset of data within the system database 1520, and a query result table 1702 comprising portions related to “rotating equipment”, as illustrated.

FIG. 18 illustrates an incident report 1800 for paper use.

FIG. 19 illustrates a portion of an electronic incident report 1900 for use on a computer.

FIGS. 20A and 20B and 21 illustrate graphical data underlying the process.

Two key indicators used to evaluate manufacturing cost effectiveness are mechanical availability and maintenance costs as a percent of replacement asset value (RAV). It is widely accepted by manufacturing companies that world class manufacturing performance means operating at greater than 97% mechanical availability and spending less than 2 percent on maintenance as a percent of RAV (FIG. 13).

Therefore, tools must be used to analyze and trend performance relative to those two measures, and employ various ‘deep dive’ methods and indicators (metrics, KPIs) which drive toward root causes of inadequate performance. To that end, I have developed a proprietary refining incident and loss database as well as process optimization methodology (via RCFA) which quantifies the economic impact (lost profit opportunity LPO) of equipment anomalies, LOPC incidents and upset/malfunction operating conditions.

Such a RCFA approach is key to analyzing and trending cost minimization, driving process optimization and maximizing process safety performance in the refining industry.

FIG. 14 illustrates . . . The plan, do, check, act elements of the LOCMS management system

The idea is to develop asset performance management (APM) products which interface with enterprise asset management big data platforms (EAM), at the center of which is an APM module featuring my proprietary refining-specific incident and loss database as well as an optimization and benchmarking methodology (utilizing RCFA) which quantifies the economic impact (lost profit opportunity LPO) of equipment anomalies, LOPC incidents and upset/malfunction operating conditions. Deploying a LOPC focused, metrics-driven management system (LOCMS FIG. 14) with an asset optimization database tool (FIG. 15) will drive improvement in operations, reliability, profitability, and most importantly process safety for use at any PSM/process facility, i.e., oil refineries, platforms, chemical plants, CNG/LNG facilities, pipelines & terminals, etc.

FIG. 15 illustrates . . . .

Incident Loss Database: Utilize a refining incident and loss database which involves a process optimization methodology (via RCFA) which quantifies the economic impact (lost profit opportunity LPO) of equipment anomalies, LOPC incidents and upset/malfunction operating conditions.

FIG. 16 illustrates . . . an incident and loss report key

Industry Comparative Benchmarking: LOPC Weighted Barrel (LWB)—a single throughput parameter as a basis for comparing refinery PSE performance >>The LOPC Intensity Index (LII) Metric. Note that LLI is not a loss but said LOPC and an index.

Commonality: Makes the case for establishing common metrics industry-wide

Industry Analysis: Highlights industry RAGAGEP standards and practices by company size and type

Data Presentation: Includes calculation methodology for each associated metric, performance ranking, aggregated peer group results, detailed gap analyses, and historical trend results by company size and type

Customized Peer Groups: Develops customized peer groups to assess specific performance shortfalls

Optimization Plans: Categorizes initiatives to maximize RAGAGEP and regulatory conformance

Each process unit is allocated a LOPC weighted barrel (LWB) factor indicative of its overall propensity for LOPC relative to RAGAGEP data. The LWB factor could be based on either: (1) A multi-year rolling average of top 10% “best in class” PSE performance by process unit (PSE #/unit throughput), or (2) A risk modifier based on an integrated analysis of gas volume, liquid volume, material (flammability and toxicity), pressure, damage mechanisms, risk-based inspection data, onsite/offsite impacts, and mitigation systems risk reduction, e.g., tankfarm=5.0, CDU=4.7, FCCU=4.3, etc.

FIG. 17 illustrates . . . Refining API 754 PSE Performance: Benchmarking “by Barrel”

Throughput of each unit is multiplied by its LWB factor:

LWBᵤₙᵢₜ=LWB factor×unit throughput

Results from each unit are added up for a refinery total:

LWB_{ref}=ΣLWBᵤₙᵢₜ (where ref=per refinery typical)

LWB_{ref} represents the predicted result, or the RAGAGEP benchmark

FIG. 17B illustrates . . . Refining API 754 PSE Performance: LWB Factor—The 10% Method

The LWB factor and resulting LWBᵤₙᵢₜ would be based on a multi-year rolling average of LOPC data (API 754 PSE Tier 1, 2, 3 history)

Then, a PSE Rate_{ref}=PSE #_{ref}/LWB_{ref} is calculated for each refinery and indicates a “per barrel” LOPC performance rate comparator

LWB_{ref} is not a benchmark in itself, but is instead a common denominator which enables a benchmarking methodology to be developed

The LWB_{ref} methodology provides a “per barrel” basis for purposes of comparison and benchmarking industry-wide

API 754 PSE rate is by workforce hours, which is counterintuitive (vs. per barrel denominator) and highly variable, e.g., skewed by man hours for major projects and turnarounds

After results from each unit are added up for a refinery total (LWB_{ref}=ΣLWBᵤₙᵢₜ), thereby indicating the “allowable” predicted, then . . .

A LOPC intensity index LII is determined for each refinery

LII_{RAGAGEP} (=1.0) is the average of the 10% “best in class” refineries, i.e., the benchmark for comparison across the industry

Each refinery's LII is calculated as follows . . .

$${LII}_{ref} = \frac{1 - ( PSE {\#}_{ref} - PSE \#10 {\%}_{line} )}{PSE {\#}_{10 \% line}} at a specific LWB$$

Industry target LII≦1.0, but a RAGAGEP allowable, or maximum threshold could be established at some point >1.0

Instead of PSE # (and LII) by unit and refinery, could be by company, release type, point of release, operating mode, consequence, DAFW injuries, fatalities, workforce, offsite impacts, PSE Tier 1-3, damage mechanism, etc.

FIG. 18 illustrates . . . LWB: a single throughput parameter as a basis for comparing refinery PSE performance >>LII

FIG. 19 and following are user interface images of the system for a software embodiment of this system.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An enterprise asset management platform, comprising:
at least one memory including computer program code; and
at least one processor;
said at least one memory and the computer program code are configured to, with the at least one processor, cause the management system to at least perform the steps of
receiving direct input from a one or more users concerning conditions of a loss of primary containment event “LOPCE” at an industrial location,
consulting a one or more outside inputs concerning said LOPCE,
diagnosing a condition of said industrial location based on said direct input and said one or more outside inputs,
optimizing said industrial location based on said condition of said industrial location, and
providing a one or more tools for managing said industrial location; and
said LOPCE comprises an active event, a possible event and/or a past event at said industrial location or similar locations.

2. The enterprise asset management platform of claim 1 wherein,
said management system further comprises a one or more key performance indicators (“KPI's”).

3. The enterprise asset management platform of claim 2 wherein,
said KPI's are developed by said one or more users by analyzing business drivers and performance indicators.

4. The enterprise asset management platform of claim 3 wherein,
said KPI's are scored and prioritized according to metrics concerned with standardization.

5. The enterprise asset management platform of claim 3 wherein,
said KPI's are scored and prioritized according to metrics concerned with sustainability.

6. The enterprise asset management platform of claim 3 wherein,
said KPI's are grouped into modules; and
modules are selected and assigned to said one or more users according to management goals.

7. The enterprise asset management platform of claim 2 wherein,
said one or more users comprise a workforce assigned to said industrial location.

8. The enterprise asset management platform of claim 2 wherein,
said KPI's are developed by analyzing risks, regulatory issues, operational issues, profits issues and continuous improvement issues.

9. The enterprise asset management platform of claim 2 wherein,
said KPI's are developed by analyzing risks by:
analyzing where risk resides and how it can be managed.

10. The enterprise asset management platform of claim 2 wherein,
said KPI's are developed by analyzing regulatory issues by:
analyzing what compliance needs exist and the point of vulnerability.

11. The enterprise asset management platform of claim 2 wherein,
said KPI's are developed by analyzing operational issues by:
analyzing measurement of operational heal and optimization thereof.

12. The enterprise asset management platform of claim 2 wherein,
said KPI's are developed by analyzing profits issues by:
analyzing economic impacts of a loss of containment and measurement thereof.

13. The enterprise asset management platform of claim 2 wherein,
said KPI's are developed by continuous improvement issues by:
analyzing sustainability options.
